(19) United States
(12) Patent Application Publication
(10) Pub. No.: US 2006/0016463 A1
(43) Pub. Date: Jan. 26, 2006

(54) Composition and process for removing titanium dioxide residues from surfaces

(75) Inventor: Joseph C. Drozd, Park Ridge, IL (US)

Correspondence Address: STOUT, UXA, BUYAN & MULLINS LLP, 4 VENTURE, SUITE 300, IRVINE, CA, 92618, US

(73) Assignee: Dober Chemical Corporation, Midlothian, IL (US)

(21) Appl. No.: 10/897,295

(22) Filed: Jul. 22, 2004

(51) Int. Cl. B08B 3/00

(52) U.S. Cl. 134/26; 134/29

(57) ABSTRACT

Methods and compositions useful for removing a titanium dioxide-containing material located on a surface, for example, a surface of a piece of process equipment, are disclosed. The methods provide for contacting the titanium dioxide-containing material located on the surface with an aqueous composition containing less than about 30% by weight of an alkali component.

### BACKGROUND OF THE INVENTION

This invention relates to removing titanium dioxide from surfaces. More particularly, this invention relates to compositions and methods for removing titanium dioxide-containing materials from surfaces, for example, surfaces of processing equipment.

Titanium dioxide is a very useful additive, it provides, for example, whiteness, opacity and protection in paints, foods, pharmaceuticals, cosmetics and various other products. Process equipment, such as vessels, coaters, piping and the like, is used to incorporate titanium dioxide into various products.

Over a period of time, such processing equipment becomes heavily coated with such titanium dioxide-containing material. Periodically, this process equipment must be cleaned in order to perform effectively. In particular, the titanium dioxide-containing material must be removed from the surfaces of the equipment in order that the equipment can perform its function effectively and efficiently. In addition, because the equipment is often used in the pharmaceutical and/or food industries, the cleaning operation itself must be effective to remove all of the titanium dioxide-containing material, and must be acceptable to, for example, the U.S. Food and Drug Administration, for use in the pharmaceutical and/or food industries. Such cleaning operations must also be cost effective.

Prior titanium dioxide removal operations have involved the use of alkaline cleaners. However, such cleaners have been unable to completely remove the titanium dioxide from the surfaces of the process equipment. Complete removal is particularly important in the food and pharmaceutical industries, where cleaned equipment is tested by sophisticated validation procedures to insure that it is sufficiently clean. In order to achieve this degree of cleanliness, costly measures have had to be implemented.

Because titanium dioxide is a widely used white pigment, many processes that involve coloring objects or fibers will result in contaminated machinery, containers, and filters. In addition, titanium dioxide scale frequently forms on titanium metal during processes used to produce objects made of the metal.

Equipment used in the manufacturing process of polyester fabric becomes contaminated with titanium dioxide. Titanium dioxide is used in the manufacture of polyester fiber primarily as a colorant and opacifier, and secondarily to prevent certain unwanted properties inherent in raw polyester fabric. During the polyester manufacturing process, liquid polyester is filtered through a media, contaminating the media with organic compounds and titanium dioxide. The filter media is typically a fine stainless steel wire mesh nickel-brazed onto a base. During cleaning, the filter is subjected to a fluidized bath containing hot aluminum oxide particles to remove organic compounds. Titanium dioxide, aluminum oxide and residual organic compounds contaminate these filters after the initial cleaning.

Pharmaceutical tablets are coated with compositions containing various binders, pigments and other additives. Residues from the coating compositions, particularly those containing titanium dioxide pigments, are very difficult or impossible to remove from the processing equipment in which the coating procedure is performed without resorting to manual methods which are difficult and very time consuming. Ultra-sonic devices can be used for facilitating removal of these residues but these devices are not suitable for large equipment.

Some conventional methods for removing titanium dioxide and residual organic compounds require immersing the contaminated workpiece in hot, concentrated alkaline solution. However, when sodium hydroxide reacts with titanium dioxide, sodium hydrogen titanate is formed, which is a gelatinous substance that is virtually impossible to remove by mechanical techniques. It is the removal of this intractable substance that requires rigorous manual work to remove. Ng, U.S. Pat. No. 3,690,949, the entire disclosure of which is incorporated herein by this reference, teaches removal of titanium dioxide scale from titanium metal workpieces using a highly alkaline cleaner containing sodium gluconate and corrosion inhibitors at 200 to 300° F. (93° C. to 148° C.). In Alexander et al, U.S. Pat. No. 2,790,738, the entire disclosure of which is incorporated herein by this reference, a method is disclosed that requires immersing a contaminated workpiece in molten alkali metal hydroxide, heated to approximately 700° F. (about 371° C.).

Chao, U.S. Pat. No. 4,292,090, the entire disclosure of which is incorporated herein by this reference, describes a method for removing titanium dioxide from a filter element by immersing a contaminated filter element in an alkaline solution made from a concentrated aqueous alkaline hydroxide solution and a calcium salt or from a basic calcium salt, for example, calcium oxide.

Dobrez et al., U.S. Pat. No. 5,763,377, the entire disclosure of which is incorporated herein by this reference, discloses compositions and methods that have been found to be effective in removing titanium dioxide from surfaces.

There remains a need for compositions and methods for more effectively and efficiently removing titanium dioxide-containing materials from surfaces of process equipment.

### SUMMARY OF THE INVENTION

New compositions and methods useful for removing a titanium dioxide-containing material located on a surface, for example, the surface of process equipment, have been discovered. The present compositions and methods provide a very useful and effective system for removing such titanium dioxide-containing materials. For example, it has been found that the use of selected materials, as described herein, in relatively low, cost effective concentrations in an aqueous medium, are effective to substantially completely remove titanium dioxide-containing materials from surfaces, for example, but not limited to, stainless steel surfaces. The degree of removal provided by the compositions and methods of the present invention preferably is sufficiently high so that the criteria set by analytical validation procedures used to determine equipment cleanliness are met with few or no further steps or cleaning procedures.

In a broad aspect of the present invention, methods are provided for removing a titanium dioxide-containing material located on a surface, for example, a non-titanium surface, for example, an interior or exterior surface of a piece of process equipment. These methods comprise contacting the titanium dioxide-containing material located on the surface with an aqueous composition, at a temperature within a range of between about 71° C. to about 82° C. and about 120° C. to about 130° C. wherein the composition preferably comprises water, an alkali component and an effective amount of a metal chelating component.

In another broad aspect of the invention, the methods for removing a titanium dioxide-containing material from a surface comprise contacting the titanium dioxide-containing material on the surface to be cleaned with an aqueous rinse for example, a rinse of pure water in order to remove a portion of the material, and thereafter contacting a remaining portion of the material with an aqueous composition containing, or consisting essentially of, about 30% by weight of an alkali component.

In some embodiments of the invention, the compositions contain less than about 30% by weight of an alkali component and an effective amount of a metal chelating agent other than sodium gluconate wherein said aqueous composition provides enhanced removal of titanium dioxide from a surface relative to a composition containing 30% by weight of the same alkali component and no metal chelating agent.

Advantageously, in some embodiments of the invention, the aqueous composition contains less than about 15% by weight of an alkali component, and in other embodiments of the invention, the aqueous composition comprises less than about 11% by weight of an alkali component.

Preferably, the aqueous composition contains between about 1% to about 10%, and more preferably between about 2% and about 5%, by weight, of the metal chelating agent.

In a particularly useful, effective, and cost efficient embodiment, the aqueous composition contains about 11% by weight of an alkali component and about 5% by weight of a metal chelating agent other than sodium gluconate. Preferably, the metal chelating agent comprises tetrasodium ethlyenediamine tetraacetic acid, preferably present in an amount of about 5% by weight of the aqueous composition.

During the contacting step, the aqueous composition preferably is at a temperature within a range of at least about 71° C., preferably at least about 81° C., for example, up to about 130° C.

In another broad aspect of the invention, methods are provided for removing a titanium dioxide-containing material from a surface, for example a non-titanium surface of a piece of process equipment, wherein the methods generally comprise the steps of contacting the titanium dioxide-containing material on the surface to be cleaned with an aqueous rinse for example, a rinse of pure water, to remove a portion of the titanium dioxide-containing material from the surface. The methods further comprise the step of subsequently contacting a remaining portion of the titanium dioxide-containing material on the surface with an aqueous composition containing at least about 30% by weight of an alkali component to thereby remove the remaining titanium dioxide-containing material from the surface. In this broad aspect of the invention, the aqueous composition may contain a metal chelating agent or no metal chelating agent.

Preferably the aqueous rinse is at a relatively cool temperature, for example, a temperature of between about 10° C. and about 30° C.

In yet another broad aspect of the present invention, compositions are provided which are effective in removing a titanium dioxide-containing material from a surface. Such compositions comprise for example, an alkali component and a metal chelating agent other than sodium gluconate.

In a preferred embodiment of the invention, the compositions comprise less than about 30% by weight of an alkali component, preferably selected from the group consisting of sodium hydroxide, potassium hydroxide, tetrapotassium pyrophosphate, trisodium phosphate and the like and combinations thereof, and between about 1% and about 10%, more preferably between 2% and 5%, by weight, of a metal chelating agent, preferably tetrasodium ethlyenediamine tetraacetic acid (Na₄EDTA) or tetrapotassium pyrophosphate (TKPP).

The present compositions and methods have been found to very effectively remove titanium dioxide-containing materials from processing equipment surfaces, preferably sufficiently so as to meet the criteria of rigorous equipment cleanliness validation procedures, for example, such as those set forth by the U.S. Food and Drug Administration, for the food and pharmaceutical industries.

These and other aspects and advantages of the present invention will become apparent in the following detailed description and claims.

### DETAILED DESCRIPTION OF THE INVENTION

Titanium dioxide is useful, for example, in coatings, in food products, medications and the like materials for human and animal consumption. In making such products, the process equipment used often becomes heavily coated with the titanium dioxide-containing materials. As part of the routine cleaning operation, a piece of equipment in question is taken out of service and processed to remove the titanium dioxide-containing material located on surfaces, for example, interior surfaces, of the equipment.

The present invention provides methods and compositions methods effective to remove such titanium dioxide-containing materials from surfaces of process equipment.

The titanium dioxide-containing materials removed in accordance with the present invention may be titanium dioxide itself, or a combination or mixture of components including titanium dioxide. For example, titanium dioxide may be applied or added to a medication or food product together with one or more other components useful to provide an independent benefit or benefits to the product and/or to facilitate the application of titanium dioxide to the product. Examples of such other components include binders, plasticizers, colorants, lubricants, fillers and the like. Such other components include those conventionally used with titanium dioxide in the production of products, such as those described herein.

Although the titanium dioxide may be present as a mixture with one or more other components, the titanium dioxide itself is believed to be particularly difficult to remove from process equipment surfaces because if its extremely small particle size and often leaves a white residue on such surfaces that is very difficult or even impossible to remove by mechanical or conventional chemical means.

The present invention has as a primary object the removal, preferably the substantially complete removal (that is the removal of at least about 90%, more preferably at least about 95% and still more preferably at least about 99% to about 100%), of titanium dioxide located on a surface.

In one embodiment of the invention, methods for removing such titanium dioxide-containing materials located on a surface comprise contacting this material with an aqueous composition containing less than about 30% by weight of an alkali component, and an effective amount of a metal chelating agent, other than sodium gluconate, wherein said aqueous composition provides enhanced removal of titanium dioxide from a surface relative to a composition containing 30% by weight of the same alkali component and no chelating agent. For example, in some embodiments of the invention, the aqueous composition contains less than 15% by weight of an alkali component, for example, the aqueous composition may contain 11% by weight of an alkali component.

The alkali component may be any suitable such component that is effective to provide the composition with the functions as described elsewhere herein particularly when combined in solution with a metal chelating agent other than sodium gluconate. Particularly useful alkali components include, but are not limited to, potassium hydroxide, sodium hydroxide, alkaline phosphates, alkaline silicates and mixtures thereof.

Preferably, the metal chelating agent comprises tetrasodium ethylenediamine tetraacetic acid (Na₄EDTA). The metal chelating agent may alternatively or additionally comprise one of the various carboxylic acids, such as citric acid, tartaric acid, and the like and mixtures thereof. In one embodiment of the invention, the chelating agent comprises a complex phosphate, preferably tetrapotassium pyrophosphate (TKPP). It is preferred that the chelating agent in the aqueous compositions of the present invention is present in the range of about 0.01% to about 10% by weight, more preferably in the range of about 2% to about 5% by weight of the aqueous composition.

It has been discovered that aqueous compositions of the present invention containing amounts of metal chelating agent greater than about 5% have not provided any more effective removal of titanium dioxide from surfaces compared with otherwise identical aqueous compositions comprising about 5% by weight or less of the same metal chelating agent. It has also been discovered that substantially lower amounts of alkali component are required, for example less than 11% by weight, to provide enhanced removal of titanium dioxide when the aqueous composition contains, in addition to the alkali component, these relatively small amounts of a chelating agent for example about 5% by weight or less.

Although not wishing to be bound by any particular theory of operation, it is believed that the metal chelating agent, in an amount of about 5% or less, is effective to assist or facilitate removing the titanium dioxide from the surface, and maintaining the titanium dioxide-containing material in the composition after it is removed from the surface, so that redeposition of this material on the surface is further inhibited. The metal chelating agent preferably is an agent other than sodium gluconate.

In some embodiments of the invention, the amount of the chelating agent included in the aqueous compositions may be selected based on the specific alkali component being employed and the specific titanium dioxide-containing material to be removed.

The present compositions may include at least one additional component to provide a beneficial property or combination of beneficial properties which allow the present compositions and/or methods to be more effective and/or more efficient in removing titanium dioxide-containing materials from surfaces. Any suitable additional component may be employed provided that it functions as described herein and has no undue detrimental effect on the present compositions and methods and the surfaces being cleaned. Examples of such useful additional components include, but are not limited to, surfactant components, coupling components, antifoam components, odorant components, colorant components and the like. If one or more of such additional components is present, it is present in an amount effective to obtain or provide the desired property or result, that is, an effective amount of such component(s). The specific amount of each additional component included in the present compositions is not critical to the present invention and may vary depending on several factors, for example, the specific additional component being used, the specific composition being employed, and the specific property to be obtained.

The surfactant component is effective to enhance the ability of the composition to wet the titanium dioxide-containing material on the surface. In other words, the surfactant component facilitates intimate contacting between this titanium dioxide-containing material and the present composition. Preferably, the surfactant component is nonionic and/or anionic. Examples of useful surfactant components include sodium polyacrylate, linear alcohol alkoxylates, poly (oxyethylkene/polyoxypropylene) monohexyl ether (as well as the corresponding monooctyl ether and monodecyl ether and combinations of any two or all three of these ethers) alkyl phenol alkoxylates, such as octyl phenol ethoxylates and nonyl phenol ethoxylates, hydrocarbyl substituted sulfonic acids, such as dodecyl benzene sulfonic acid, and the like and mixtures thereof. Specific surfactants include: those sold by Huntsman under the trademarks Surfonic N-95 and Surfonic N-40; that sold by Olin under the trademark Polytergent SLF-18; and those sold by Rohm and Haas Company under the trademarks Triton X-15, Triton X-35, Triton X-45, Triton X-114, Triton X-100, Triton X-102 and triton X-165. Preferably, the surfactant component is present in an amount in the range of about 0.1% or about 0.5% or about 5% or about 20% by weight of the composition, for example is present in an amount of about 0.8% by weight of the composition.

In some instances, in accordance with the present invention, a piece of process equipment is cleaned and rinsed and the final rinse fluid is monitored for the presence of alkoxylates. If the concentration of alkoxylates in the final rinse fluid is below a set limit, the equipment is verified or validated to be acceptably clean. If the concentration of alkoxylates is too high, additional cleaning and/or rinsing step or steps must be undertaken before the equipment can be certified to be clean and ready to be put back into service.

In some embodiments of the present invention, the coupling component is effective to enhance the compatibility, for example, the miscibility or solubility, of the various other components in the present compositions. Such coupling components often include both polar portions, for example, hydroxyl-containing groups, and non-polar portions, for example, organic groups. Examples of useful coupling components include alcohols, glycols, glycol ethers and the like and mixtures thereof. A particularly useful coupling component in the present invention is isopropyl alcohol. Preferably, the coupling component is present in an amount in the range of about 0.05% or about 0.2% to about 5% or about 10% of the aqueous composition.

The antifoam component is effective to inhibit or even prevent the formation of foam during use of the present compositions. Silicon-containing materials, commonly sold as antifoam agents, are sometimes effective in the present invention. For example, an antifoam component may be present in an amount in the range of about 0.001% to about 0.5% by weight of the aqueous composition.

The present aqueous compositions may be derived from concentrates, for example, by combining water and a concentrate or concentrates. These concentrates, which may comprise relatively large concentrations of the active components described elsewhere herein are considered to be within the scope of the present invention. Such concentrates may include an inert component or diluent, for example, water, for example, about 20% by weight of water. The specific amounts of the various components of the present compositions noted above generally refer to the amount of the active component without considering any inert component or diluent.

In accordance with the present invention, a method for removing titanium dioxide from surfaces may include the step of contacting the titanium dioxide-containing material located on the surface of equipment, with the aqueous compositions described herein, at conditions effective to remove such material. Although ambient or room temperature conditions can be employed, it is sometimes preferable to use relatively elevated temperatures, preferably at least about 50° C. during such contacting. For example, in order to obtain such temperatures the composition may be passed through a heat exchanger prior to introducing the composition onto the equipment to be cleaned.

Effective contacting times may vary depending, for example, on the specific composition and contacting conditions being employed and on the specific removal application involved. Preferably, such contacting occurs for a time in the range of about 30 seconds or about one minute to about 1 hour to about 2 hours to about 3 hours. In addition, in some embodiments of the present invention, the composition can be used for removing titanium dioxide residue on a “once-through”, or single pass basis. More specifically, in these embodiments of the invention, the composition is passed into or onto the equipment to be cleaned only a single time, rather than being recirculated or recycled back through the equipment to be cleaned. Alternatively, in other embodiments of the invention, the composition, after being passed into or onto the equipment to be cleaned, is cycled back or passed back to the equipment or other equipment.

In one embodiment of the invention, the titanium dioxide-containing material on the surface is initially contacted with an aqueous rinse, for example, a rinse of pure water to particularly dissolve and to impact the titanium dioxide-containing material on the surface with sufficient force, for example, at a pressure about 30 or about 50 psi, to mechanically remove at least a portion of the titanium dioxide-containing material from the surface. Preferably, the aqueous rinse is at a temperature of between about 10° C. and 30° C. during this step.

Next, the method comprises contacting a remaining portion of the titanium dioxide-containing material located on the surface with an alkaline composition at a temperature in a range of about 71° C. to about 120° C., thereby removing at least some of, preferably substantially all of, the remaining portion from the surface.

In this embodiment, the alkaline composition may contain water and about 30% by weight of an alkali component, and in addition may contain no chelating agent.

Electric conductivity measurements of the composition and the rinse medium may be employed, for example, to maintain the “strength” of the composition used for removing the titanium dioxide-containing material, particularly when the composition is being used in a “recycle” mode, and to validate the cleanliness of the equipment after the equipment has been cleaned.

For example, the electric conductivity of the spent composition may be monitored as the composition exits the equipment to be cleaned. One can determine, at least semi-quantitatively, the “strength” of this composition, that is the ability of the composition to remove further titanium dioxide-containing material based upon the electric or electrical conductivity of the composition. Generally, all other things being equal, the ability of the composition to remove titanium dioxide-containing material is directly proportional to, that is increases with increases in and decreases with decreases in, the electrical conductivity of the composition. By monitoring the electrical conductivity, and thus the “strength” of this composition, one can determine whether or not active material concentrate needs to be added to the composition being used. Preferably, sufficient active material concentrate is added to the recirculating composition so as to maintain the “strength” of the composition at a certain level. This electrical conductivity monitoring and composition strength controlling function is preferably accomplished by an electronic controller, such as that included in the system sold by Dober Chemical Corporation under the trademark Chematic C.I.P.

Various types of analytical equipment and instruments may be used to validate the cleanliness of a piece of equipment after treatment with the present compositions. After the treatment, preferably including rinsing, an area of the treated equipment surface is swabbed to collect any cleaning composition residue. This residue can then be dissolved in a suitable solvent and the residue-containing solvent is analyzed. The cleanliness of the piece of equipment is validated when the analysis is within acceptable limits.

After the piece of equipment has been validated as being clean, it can be returned to service, for example, in the food or pharmaceutical industry to coat products with a titanium dioxide-containing material.

In some embodiments of the present invention, a cool water pre-rinse step is not necessary for the effectiveness of the method in removing titanium dioxide residue from a surface. The necessity of a cool water pre-rinse step depends, at least in part, upon the source of the titanium dioxide coating. It has been found that surfaces coated with Opandry II typically require a pre-rinse step.

The following non-limiting examples illustrate certain aspects of the present invention.

### EXAMPLE 1

Surfaces of stainless steel items are coated with the pharmaceutical tablet coating marketed under the trademark Opadry® II White (proprietary binders and titanium dioxide) manufactured by Colorcor, Inc.

These test surfaces include inside surfaces of several 90 degree bend stainless steel pipe fittings and entire outer surfaces of several stainless steel test coupons.

After being coated with the pharmaceutical tablet coating material, the items are allowed to air dry. The items now have a titanium dioxide coating.

The coated items are subjected to a rinse of cool (about 10° C. to about 30° C.) tap water, which removes some of the coating.

A thin white residue remains on the items after the cool water rinse. The white residue proves to be difficult to remove by using other than mechanical means.

The prerinsed items are immersed in a stirred aqueous solution of 30% by weight NaOH at a temperature of about 71° C. which is gradually increased to about 110° C. within one hour.

The items are removed from the solution and are rinsed with cool tap water.

Results achieved are very good. No white residue remains on the items.

### EXAMPLE 2

Example 1 is repeated except that the coated items are not subjected to a cool water rinse prior to immersion in the stirred aqueous 30% NaOH solution.

Results achieved are not good. In fact, the items are even more difficult to clean than before they were immersed in the stirred aqueous solution of 30% by weight NaOH.

### EXAMPLE 3

Example 1 is repeated except that the stirred aqueous solution of 30% by weight NaOH is at a temperature of between about 120° C. to about 130° C.

Results achieved are very good. No white residue remains on the items after only about 15 minutes of immersion in the solution, and rinsing with cool tap water.

### EXAMPLE 4

Example 1 is repeated except that the stirred aqueous solution is replaced by a stirred aqueous solution of 30% by weight KOH.

Results achieved are very good. No white residue remains on the items.

### EXAMPLE 5

Chemical processing equipment of stainless steel construction are coated with Opandry II. More particularly, the surfaces coated with the pharamaceutical tablet coating comprise the inside surfaces of each of several large industrial stainless steel tanks, pipes and valves. The surfaces are allowed to air dry.

The surfaces are rinsed with cool tap water to remove most of the coating. A white titanium dioxide film remains on the surfaces.

An aqueous solution comprising 22% by weight KOH and 10% by weight Na₄EDTA (metal chelating agent) is continuously sprayed onto the coated surfaces at a temperature of about 82° C., a flow rate of about 10 to about 12 gallons per minute and a pressure of about 20 psi to about 26 psi. The equipment is then rinsed with cool tap water until the rinsate pH is 7.

Results are that the inside surfaces of the tanks and fittings are completely clean and free of titanium dioxide residue within about two hours.

### EXAMPLE 6

Example 5 is repeated except that the aqueous solution comprises 22% by weight KOH and 9% by weight sodium gluconate.

Results are that the test surfaces are not cleaned using this solution, even after being sprayed for three hours.

### EXAMPLE 7

Example 5 is repeated except that the aqueous solution comprises 22% by weight KOH and 9% by weight sodium citrate.

Results are that the test surfaces are not cleaned using this solution, even after being sprayed for three hours.

### EXAMPLE 8

Items from Examples 6 and 7 that are not cleaned after being continuously sprayed are again continuously sprayed with the aqueous solution of Example 5.

Results are very good in that the aqueous solution of Example 5 is effective to clean, within about 2 hours, the items that could not be cleaned by the aqueous solutions of Examples 6 and 7. This Example demonstrates that the alkaline composition including Na₄EDTA is effective in removing titanium dioxide material from surfaces, but aqueous solutions including sodium gluconate and sodium citrate, in place of Na₄EDTA, are not effective.

### EXAMPLE 9

Example 5 is repeated except that an aqueous solution including 15% by weight KOH and 3% by weight sodium silicate is used.

Results are good but not as good as the results in Example 5, even after 3 hours of being continuously sprayed with the aqueous solution.

### EXAMPLE 10

Example 5 is repeated except that an aqueous solution including 11% by weight KOH and 5% by weight Na₄EDTA is used.

Results are very good in that the surfaces have no titanium dioxide residue remaining after only about 2 hours of being sprayed with the aqueous solution.

Examples 9 and 10 demonstrate that KOH concentration at 15% by weight in aqueous solution was too low to be highly effective in removing titanium dioxide residue when used in combination with sodium silicate. However, such KOH concentration in an aqueous solution is highly effective to remove titanium dioxide residue when the solution includes even a small amount of Na₄EDTA

### EXAMPLE 11

The inside surfaces of stainless steel tanks are coated as in Example 5. An aqueous solution of 27% by weight KOH and 13% by weight tetrapotassium pyrophosphate is prepared and is continuously sprayed onto the coated surfaces at a temperature of 82° C. at a flow rate of about 10 gallons per minute to about 12 gallons per minute and a pressure of about 20 psi to about 26 psi.

Results are that the inside surfaces of the tanks are clean and free of titanium oxide reside within about two hours.

### EXAMPLE 12

The inside surfaces of each of several stainless steel tanks is coated as in Example 5 and are allowed to air dry. Then they are “precleaned” by rinsing with cool water.

An aqueous solution is prepared containing 28% by weight KOH, 13% by weight Na₄EDTA, 0.8% by weight sodium polyacrylate, 0.9% by weight potassium silicate, and 0.5% by weight sodium nitrate.

The aqueous solution is sprayed onto the coated tank surfaces at 82° C. at a flow rate of about 10 to about 12 gallons per minute and a pressure of about 20 psi to about 26 psi.

Advantageously, the composition appears to be low foaming during the spraying.

Within the one to two hours of spraying, and a rinse with water to pH 7, the titanium dioxide coating is completely removed from the surfaces of the tanks.

While this invention has been described with respect to various specific examples and embodiments, it is to be understood that the invention is not limited thereto and that it can be variously practiced within the scope of the following claims.

1. A method for removing a titanium dioxide-containing material located on a non-titanium surface, the method comprising:
contacting a titanium dioxide-containing material located on a non-titanium surface with an alkaline aqueous composition comprising water, an alkali component and a metal chelating agent other than gluconate, thereby removing the titanium dioxide-containing material from the surface, the aqueous composition including an amount of the metal chelating agent effective to provide enhanced removal of the titanium dioxide-containing material from the surface relative to an identical alkaline aqueous composition containing gluconate in place of the metal chelating agent.

2. The method of claim 1 wherein the surface is a stainless steel surface and the aqueous composition contains less than about 15% by weight of the alkali component.

3. The method of claim 1 wherein the aqueous composition contains less than about 11% by weight of the alkali component.

4. The method of claim 1 wherein the aqueous composition is at a temperature in a range of between about 71° C. and about 130° C. during the contacting step.

5. The method of claim 1 wherein the aqueous composition is at a temperature of less than about 130° C.

6. The method of claim 1 wherein the alkali component comprises sodium hydroxide.

7. The method of claim 1 wherein the alkali component comprises potassium hydroxide.

8. The method of claim 1 wherein the aqueous composition contains between about 1% and about 5% by weight of the metal chelating agent.

9. The method of claim 1 wherein the metal chelating agent comprises tetrasodium ethlyenediamine tetraacetic acid.

10. The method of claim 1 wherein the aqueous composition contains an effective amount of a wetting/penetration agent.

11. The method of claim 10 wherein the wetting/penetration agent comprises sodium lignosulfate.

12. The method of claim 1 wherein the aqueous composition includes an effective amount of a surfactant component.

13. The method of claim 12 wherein the surfactant component comprises sodium polyacrylate.

14. The method of claim 1 wherein the aqueous composition includes an effective amount of a corrosion protectant.

15. The method of claim 14 wherein the corrosion protectant is selected from the group consisting of potassium silicate, sodium nitrite and mixtures thereof.

16. The method of claim 1 wherein the aqueous composition comprises less than about 30% by weight of an alkali component and about 5% by weight of a metal chelating agent.

17-28. (canceled)

29. The method of claim 1 wherein the metal chelating agent comprises tetrapotassium pyrophosphate.

30. The method of claim 1 wherein the alkali component comprise potassium hydroxide and the metal chelating agent comprises tetrasodium pyrophosphate.

31-33. (canceled)

34. The method of claim 1 wherein the alkali component is present in the composition in an amount of less than about 30% by weight of the composition.

35. The method of claim 1 wherein the metal chelating agent comprises an agent selected from the group consisting of ethylenediamine tetraacetic acid, ethylenediamine tetraacetate and pyrophosphate.

36. The method of claim 1 wherein the metal chelating agent comprises ethylenediamine tetraacetate.

37. The method of claim 1 wherein the metal chelating agent comprises pyrophosphate.

38. The method of claim 1 wherein the metal chelating agent is present in the aqueous composition in an amount in a range of about 0.01% to about 10% by weight of the aqueous composition.
